(19) United States
(12) Patent Application Publication
(10) Pub. No.: US 2012/0045369 A1
(43) Pub. Date: Feb. 23, 2012

(54) CHEMICAL ANALYSIS APPARATUS

(75) Inventors: Charles GREENSTED, Gloucestershire (GB); Eric D'COSTA, Wotton-under-Edge (GB); Katherine WILLIAMS, Rodborough (GB); Sunny BHACHOO, Brockworth (GB)

(73) Assignee: ABB TECHNOLOGY AG, Zurich (CH)

(21) Appl. No.: 13/213,793

(22) Filed: Aug. 19, 2011

(30) Foreign Application Priority Data
Aug. 20, 2010 (EP) 10008720.4
May 27, 2011 (EP) 11004360.1
Jul. 19, 2011 (EP) 11005891.4

(51) Int. Cl. G01N 21/78

(52) U.S. Cl. 422/82.05

(57) ABSTRACT

A chemical analysis apparatus is disclosed as having a liquid flow train assembly for creating a flowing liquid sample stream guided from a sample inlet through the apparatus in a capillary tubing arrangement at low liquid flow rates, the sample containing an analyte to be measured; a reagents dosing and injection device located downstream the sample inlet for introducing a series of chemical reagents into the sample stream; a reactor where the reagents react with the analyte for producing a colored chemical indicator in the fully reacted sample; and a detection for measuring the chemical indicator, located downstream of the reactor means and being configured to receive the fully reacted sample with the colored indicator from the reactor means. The flow train assembly can intermittently let the fully reacted sample pass through the detector when the measurement of the indicator is not made, and to bypass the detector when the measurement of the chemical indicator in the sample is made.

### RELATED APPLICATION

This application claims priority under 35 U.S.C. §119 to European Patent Application No. 10008720.4 filed in Europe on Aug. 20, 2010, European Patent Application No. 11004360.1 filed in Europe on May 27, 2011 and European Patent Application No. 11005891.4 filed in Europe on Jul. 19, 2011. The entire contents of these applications are hereby incorporated by reference in their entireties.

### FIELD

The disclosure relates to a chemical analysis apparatus and methods. The disclosure also relates to a continuous measurement chemical analyzer for water quality monitoring.

### BACKGROUND INFORMATION

A known continuous chemical analyzer platform for water quality measurement is based upon a temperature-controlled continuously flowing sample stream into which is introduced a series of chemical reagents in a fixed sequence. The analyzer platform is designed to measure a number of different analytes depending on the reagents used.

As an example, in a continuous chemical analyzer for silica, the reaction sequence for the measurement is as follows:

1) First acidification of silica in sample;

2) Reaction of silica in sample with molybdate reagent to form yellow β-molybdosilicic acid;

3) Second acidification to prevent the formation of further βmolybdosilicic acid;

4) Reduction of yellow β-molybdosilicic acid to the blue molybdosilicic acid complex; and

5) Measurement of the absorbance of blue molybdosilicic acid.

Under this scenario, the analyte of interest is carried in the sample stream through the analyzer's thermostatically maintained reaction coil at a controlled liquid flow-rate and reacts with each of the inflowing reagents in turn. The linear distance between the inflow junctions of the reagents together with the set liquid flow rate and control temperature determines the incubation time and conditions required for each of the specific reactions in the sequence. At the end of the sequence, the resulting developed colored indicator substance, here blue molybdosilicic acid, passes through the measuring cuvette. The color intensity of the indicator substance is determined at a specific wavelength and is proportional to the concentration of the analyte of interest in the sample under test. When required, a calibrant solution or a cleaning solution can be substituted for the sample to calibrate or clean the analyzer. FIG. 1 shows the principle of operation of such a known continuous analyzer device.

One advantage embodied in the known design is the possibility to design it for extremely low reagent usage allowing the analyzer to run unattended for several months without the requirement to refill reagent reservoirs. This can be achieved through miniaturization of the liquid flow train using capillary tubes and a lowering of the liquid flow rates within the analyzer. Flow rates from 15 μl min⁻¹ to 240 μl min⁻¹ are an example for the reagents and sample respectively to achieve such long unattended operation times.

The internal diameter of the thermostatically maintained reaction coil and other tubing in the liquid flow train are in the case of the example above approximately 1 mm. However, the capillary reactor system with its narrow bores can produce noisy signals as a result of entrained air and poor mixing.

Under good homeostatic control, dissolved gasses in typical samples under test outgas from solution in the analyzer's pre-heating capillary coil and are removed in a primary debubbler. Bubbles resulting from further outgassing of the sample, as it passes through the capillary reaction coils, are removed in a secondary debubbler which is placed immediately upstream of the measuring cuvette. Outgassed bubbles are carried along in the liquid flow train until they emerge in the debubblers where they are removed. As the bubbles travel along the reaction capillary coil, they alter how the reagents mix into the flowing sample.

Even though the bubbles do not pass through the cuvette, the effect they have on the reaction due to an interruption of mixing is detected optically in the cuvette as a temporary bipolar change in the color intensity or refraction produced in the flowing stream, detected as a spike. Such spiking of the measured signal would be observed as a noisy measurement and is not acceptable in operation. Such noisy signals limit the resolution of the measurement and spikes could falsely trigger instrument process alarms. The characteristic of this bubble-related spike is consistent during the analyzer's operation to the extent that under normal measurement conditions it can be recognized and removed through the application of a custom digital signal processing (DSP) algorithm to yield a less noisy measurement.

Although under normal operating conditions a DSP algorithm significantly improves the quality of the measured signal through the removal of the bubble-related spike, certain analyzer conditions or modes of analyzer operation can change the characteristic of the bubble-related spike such that the DSP algorithm may no longer be able to fully smooth out the measured signal.

With the silica instrument for example, during calibration and auto-zero operations, if the DSP algorithm fails to fully eliminate the bubble-related spike, an incorrect drift compensation or silica compensation offset will be applied to the signal resulting in small measurement errors. If this happens during sequential calibrations or auto-zero operations, the measured value will be seen to make small step changes (either showing increased or decreased silica concentration). Potentially this could result in a below zero silica measurement.

When the silica instrument is operating in multi-stream mode, where up to six different sample streams can be switched into the liquid flow train as the measured sample flowing into the instrument, the time to apply a DSP algorithm is short with very little data available to the algorithm. The result of this is that if a bubble-related spike occurs at the point the multi-stream DSP algorithm is analyzing the data, an incorrect measurement may be returned from the algorithm due to the reduced quality of the available signal data.

When a silica analyzer has been running for several days or weeks, depending on the nature of the sample and analyte concentration, the capillary tubing can adsorb insoluble materials that subtly change the surface of the tubes and subsequently alter the characteristic of the bubble-related spike. If such changes are significant, the DSP algorithm could no longer recognize the bubble-related spike, fail to fully eliminate its effects and an unacceptably noisy measured signal would be seen as a result.

On occasions bubbles passing through the reaction coils could become variable in size and appear at varying frequencies. This means that the bubble-related spikes would also variable in character and as a consequence they might not be filtered out fully by a DSP algorithm. The same situation may occur when two or more bubbles are travelling through the reaction coils in close proximity to one another. In this case, a DSP algorithm may not filter out the resulting bubble-related spikes because they could not be recognized as perturbations that should be filtered out.

### SUMMARY

A chemical analysis apparatus is disclosed comprising: a liquid flow train assembly for creating a flowing liquid sample stream guided from a sample inlet through a capillary tubing arrangement at low liquid flow rates, the sample containing an analyte to be measured; reagents dosing and injection means, located downstream from the sample inlet, for introducing a series of chemical reagents into the sample stream; reactor means where the reagents are reacting with the analyte for producing a colored chemical indicator in a fully reacted sample; and detection means for measuring the chemical indicator, said detection means being located downstream of the reactor means and being configured to receive the fully reacted sample with the colored indicator from the reactor means, wherein the flow train assembly is configured to intermittently let the fully reacted sample pass through the detection means at times when a measurement of the indicator is not made, and to bypass the detection means at times when a measurement of the chemical indicator in a sample contained within the detection means is made.

A chemical analysis apparatus is disclosed comprising: a sample inlet, and a capillary tubing arrangement, wherein a flowing liquid sample stream containing an analyte to be measured will flow from the inlet, and through the capillary tubing; reagent dosers and injectors located downstream from the sample inlet, wherein the dosers and injectors are configured and arranged to introduce a series of chemical reagent into the sample stream; a reactor configured to produce a colored chemical indicator in a fully reacted sample contained therein; and a detector disposed downstream from the reactor, the detector being configured to receive the fully reacted sample from the reactor, and measure the chemical indicator, wherein the apparatus is configured to intermittently allow the fully reacted sample to pass through the detector when measurement of the chemical indicator is not being made, and to bypass the detector when measurement of the chemical indicator is being made by the detector.

### BRIEF DESCRIPTION OF THE DRAWINGS

The disclosure will be described in greater detail by description of an embodiment with reference to the accompanying drawings, wherein:

FIG. 1 shows a principle of operation of a known chemical analyzer;

FIG. 2 shows a principle of operation of a chemical analyzer according to a first exemplary embodiment of the disclosure, with a capillary tube reactor;

FIG. 3 shows a principle of operation of a chemical analyzer according to a second exemplary embodiment of the disclosure, with a sequential flow-through stirred reactor;

FIG. 4 shows a schematic view of a valve manifold module incorporating a debubbler, according to an exemplary embodiment of the disclosure;

FIG. 5 shows a manifold module in combination with a valve body;

FIG. 6 shows an assembly of a valve module with a valve and with a measuring cuvette; and

FIG. 7 shows an exploded view of a pre-heater module according to an exemplary embodiment of the disclosure.

### DETAILED DESCRIPTION

A chemical analysis apparatus is disclosed which can reduce measurement noise and improve reliability of the measurement, with reduced bubble-related spiking of the measurement signal.

According to exemplary embodiments of the disclosure, a flow train assembly is configured to intermittently let the fully reacted sample pass through detection means at times when the measurement of the indicator is not made, and to bypass the detection means at times when the measurement of the chemical indicator in the sample contained within the detection means is made.

One advantage of exemplary designs according to the disclosure is that the measurement is made when the fully reacted sample is positioned within, but not flowing through, the measurement cuvette. Such a design has been found to reduce the measurement noise to a low value and to eliminate the effects of bubble-related spikes in the measurement.

According to an exemplary embodiment, a liquid flow train assembly is disclosed for creating a flowing liquid sample stream guided from a sample inlet through an apparatus in a capillary tubing arrangement at low liquid flow rates, the sample containing an analyte to be measured, the apparatus comprising reagents dosing and injection means, located downstream the inlet, for introducing a series of chemical reagents into the sample stream; reactor means where the reagents are reacting with the analyte for producing a colored chemical indicator in the fully reacted sample; and detection means for measuring the chemical indicator, said detection means being located downstream the reactor means and being configured to receive the fully reacted sample with the colored indicator from the reactor means.

According to an exemplary embodiment of the disclosure, an apparatus comprises a flow diversion valve assembly, said valve assembly being located upstream of the detection means or detector and downstream of the reactor means or reactor, said valve assembly being configured to let the fully reacted sample pass through the detection means or detector at a first time interval when the measurement is not being made, and to let the sample flow pass by the detection means or detector, leaving the sample inside the detection means or detector in a static state at a second time interval when the measurement is being made.

So advantageously, an exemplary design according to one aspect of the disclosure interposes a flow-diversion valve downstream of the secondary debubbler and immediately upstream of the measuring cuvette.

At such times when the measurement is not being made, the flow diversion valve is switched to allow the flowing, fully reacted sample, to pass through the cuvette; thus refreshing the sample.

When the measurement is to be made, the flow of fully reacted sample is diverted by the flow diversion valve to waste. In so doing, the last contemporary, fully reacted sample, remains in a static state in the measuring cuvette and the measurement is then made under quiescent conditions.

In chemical analysis apparatuses, the entire flow of reacting sample through the whole reactor chain has to be stopped for the measurement.

According to the disclosure, diverting the fully reacted sample to waste whilst the measurement is in progress allows beneficially the reaction chemistry to continue uninterrupted, in the background, in the capillary reactor and ensures that the next sample measurement is made on a contemporary sample.

In this way the sample switching and reaction chemistry is allowed to proceed continuously but the measurement is made intermittently on the background of continuous sampling and continuous reaction chemistry.

This mode of measurement can be especially effective in producing an accurate measurement when operating the instrument in multi-stream mode. This is because time consuming and very complex software filtering, that would otherwise be required, is eliminated; thus preserving the shortest possible response time between un-segmented continuous samples.

As explained above, one of the main contributors to measurement noise is entrained air bubbles in the reacted sample stream. These can be removed in a primary debubbler which would be situated upstream of the reaction coils and in a secondary debubbler module which would be situated downstream of the reaction coils but upstream of the measuring cuvette.

According to a further exemplary embodiment of the disclosure, the valve assembly comprises a valve body and a valve manifold module, whereby the valve manifold module incorporates a debubbler means or debubbler.

According to a further exemplary embodiment of the disclosure, the detection means or detector is coupled to the valve manifold module.

One advantage of this embodiment of the disclosure is that the secondary debubbler is mounted immediately upstream the measuring cuvette, with a very short flow distance between the secondary debubbler and the measuring cuvette. The secondary debubbler is designed as part of a single combination module that incorporates the stopped-flow diverter valve manifold such that the flow diversion valve assembly is interposed directly between the secondary debubbler and the cuvette. In this way the design ensures that there is a minimum of liquid dead volume in the assembly. It has been found that this design results in a particularly accurate low-noise measurement.

According to a further exemplary embodiment of the disclosure, the flow train assembly comprises further a flow-through pre-heater module, located upstream of the reactor means or reactor, but separate and thermally insulated therefrom.

One advantage of this embodiment is that the temperature of the pre-heating of the sample can be set independently from the temperature of the reactor means or reactor. In prior art chemical analysis apparatuses, the pre-heater always is thermally connected to the reactor means or reactor, thus not allowing to set the temperature of the pre-heated sample independent from the temperature within the reactor means or reactor, for example, to a higher value than inside the reactor means or reactor.

According to a further exemplary embodiment of the disclosure, the pre-heater module is configured to raise the temperature of sample stream to a higher temperature than the reaction temperature in the reactor means or reactor.

According to a further exemplary embodiment of the disclosure, the flow train assembly further comprises a primary debubbling means or debubbler, located downstream the pre-heater module and upstream the reactor means or reactor.

So the physical separation and distinction of the pre-heater module from the reactor module or reactor means advantageously allows to raise the temperature of the influent sample before it passes through the primary debubbler module. For example, for a short period of time, the sample temperature is raised to a higher temperature than that maintained in the reactor means or reactor module, for example, a capillary flow-through reactor.

This has the effect of forcing dissolved gasses out of solution to form physical bubbles in the flowing stream. The resulting bubbles carried in the sample stream are removed from the sample stream when it passes through the primary debubbler.

This operation ensures that most of the dissolved and entrained gasses, contained in the sample before it enters the analyzer, are removed from the sample before it enters the reactor means or reactor, for example, a capillary flow-through reactor, where it encounters the reagents.

It has been found particularly advantageous to first raise the sample to a significantly higher temperature than the subsequent reaction temperature. This is because even if the sample is pre-equilibrated to the same temperature as the reaction temperature before the primary debubbler, there can still remain some residual gasses dissolved in the sample that are subsequently forced out of solution when the reagents, with higher ionic strength, meet and mix with the sample. At the point that happens, the sample has already passed the primary debubbler and these so formed air bubbles can not be removed and have a detrimental effect on the measurement as explained earlier.

When a pre-heater is employed, virtually all of the dissolved gas, e.g., air, originally dissolved in the sample, is forced out of solution and removed before the sample cools to the reaction temperature and mixes with the reagents; there is virtually no residual dissolved gas, e.g., air, left in the sample that can be forced out of solution by the higher ionic strength of the reagents.

The intermittent or stopped flow measurement technique and incorporation of a pre-heater module may be used with different embodiments of reactor means or reactors according to the disclosure, either with the capillary flow-through reactor or with the sequential flow-through stirred reactors, or with any other continuous or discontinuous flow-through reactor methodology or design.

So according to a further exemplary embodiment of the disclosure, the reactor means or reactor is a capillary flow-through reactor.

According to a further exemplary embodiment of the disclosure, the reactor means or reactor is a sequential series of reaction chambers for sequentially segmenting the reaction of the reagents with the analyte into a series of partial reactions. The advantageous characteristics of such a sequentially segmented reactor arrangement is that reactants in each of the segmented reactors are allowed to enter the lower region of the chamber and, based on the flow rates, have a residence time within the chamber such that the desired reaction is substantially completed by the time the contents flows out of the chamber respectively into the next sequential reaction chamber in series.

According to a further exemplary embodiment of the disclosure, each reaction chamber is connected to at least one of the reagents dosing and injection means or reagent dosers and injectors, whereby in each reaction chamber at least one of the partial reactions is performed.

According to a further exemplary embodiment of the disclosure, each of the reaction chambers comprises active stirring means or active stirrers.

According to a further exemplary embodiment of the disclosure, active stirring means or active stirrers are mechanical stirring means or stirrers for mechanically stirring the sample and reagents, or comprise at least a magnetic follower agitated by a magnetic drive coupling device.

So according to this disclosure the chemical analysis apparatus include, or consist of, a temperature-controlled continuous or discontinuous flow-through reactor through which sample, containing the analyte of interest, flows continuously. Reagents are introduced in an ordered sequence to produce a colored chemical indicator, and the indicator is measured in a stopped-flow mode in a through optical sensor. The color intensity of the indicator is proportional to the concentration of the analyte of interest. Consequently, the signal is much quieter, eliminating the measurement errors resulting from bubble-induced noise.

An exemplary embodiment according to the disclosure is especially useful in relation to continuous, semi-continuous or discontinuous chemical analyzers where solutions are required to mix together, actively or passively, in restricted volumes. It is a requirement for the development of chemical analysis apparatuses for use in the process or water and waste water industry to increase the time intervals between service. This can be achieved by reducing the consumption of consumables like reagents in the instrument. This again leads to the need to reduce the size of the tubing applied in the analysis apparatus, and to reduce the flow rates and volumes affected. Most typically, analyzers incorporating capillary or small-bore tubing will be susceptible to measurement noise and inaccuracies in relation to entrained gas, e.g., air, air bubbles. Such problems with gas, e.g., air bubbles, become the more severe the smaller the scale of the tubing and volumes. Low liquid flow rates contribute to measurement noise and inaccuracies in relation to entrained gas, e.g., air. It is important not to stop the reaction in the reactor when small volumes are applied.

In case a gas, e.g., air bubble, is entrapped in the flow within a very narrow bore capillary, the flow profile within the capillary will develop a typical bubble glitch as the flow velocity at the capillary wall is very low, and the flow velocity in the center of the capillary is much higher that at the boundary. Such a bubble glitch profile is disadvantageous if it happens in a small bore measurement cuvette. So by stopping the flow during measurement in the cuvette, such bubble glitches will have time to equilibrate, improving the measurement accuracy.

An exemplary design according to the disclosure provides the advantage, that, although the analyte solution is in quiescent state in the measuring cuvette during measurement times, the reaction in the reaction flow never stops in the reactor. This is not achievable with known devices.

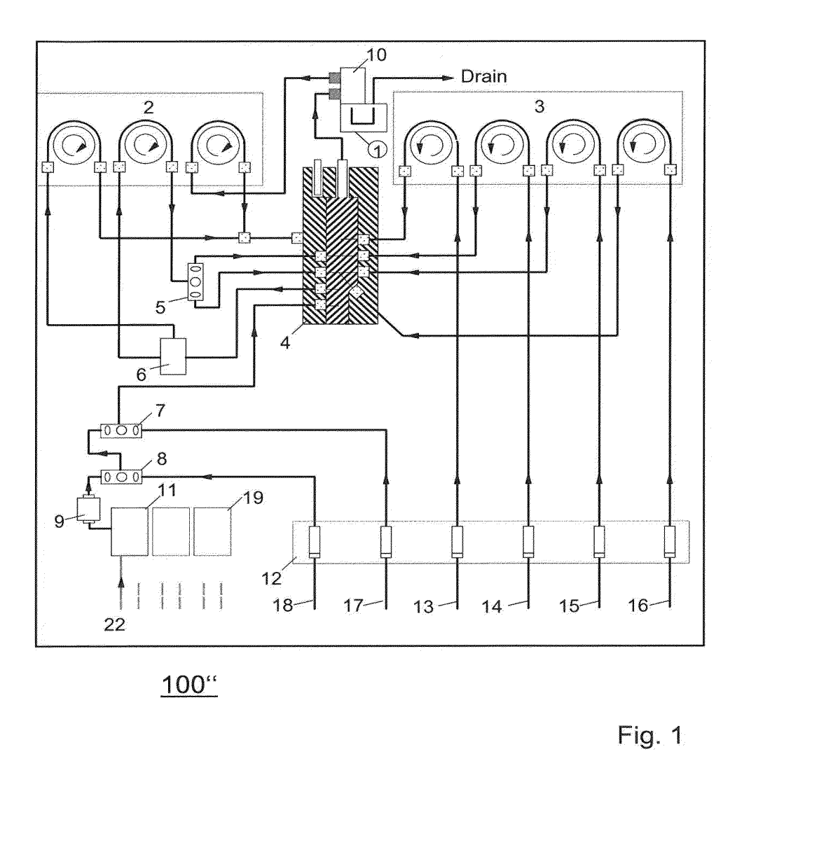

FIG. 1 shows a chemical analysis apparatus 100″ for silica monitoring according to prior art. A peristaltic pump arrangement 2 is driving a flowing liquid sample stream from a sample inlet 22 to a drain. The liquid sample enters the inlet 22 at a constant-head unit 11. For operation in a multi-stream mode several sample inlet lines are foreseen, each sample line entering one of additional constant head units 19. After passing through an in-line filter 9 the liquid flow train passes through a cleaning solution solenoid valve 8, which has a cleaning solution feeding port which is fed via a level sensor and filter 12 and a cleaning solution inlet 18 out of a cleaning solution reservoir, which is not shown in the figure.

Downstream of the cleaning solution solenoid valve 8 there is a calibration solenoid valve 7, which has a calibration solution feeding port which is fed via a level sensor and filter 12 and a calibration solution inlet 17 out of a calibration solution reservoir, which is not shown in the figure.

Further downstream the calibration solenoid valve 7 the sample flow stream enters the lower part of a capillary flow-through reactor 4, which is pre-heated to a reaction temperature, chosen in adaption to the specific chemical reaction and usually above ambient temperature. The heater arrangement is not shown in the figure, but is arranged in such a way that the whole reactor 4 is kept homogenously at the reaction temperature.

The pre-heated sample leaves the reactor 4 to enter into a primary debubbler 6, downstream of which it is driven by one of the peristaltic pumps 2 to a zero calibration solenoid valve 5. Downstream the zero calibration solenoid valve the sample stream again enters the reactor 4. Here a series of chemical reagents is introduced to the sample in a fixed sequence. Each reagent enters via a reagent dosing and injection means, driven by one of the peristaltic reagent pumps 3, fed via a level sensor and filter 12 out of a reagent reservoir, which are not shown in the figure. First reagent is a first acid reagent 16, for first acidification of silica in the sample. Second reagent is ammonium molybdate reagent 15 for reaction of silica in the sample with the molybdate reagent to form yellow β-molybdosilicic acid. Third is a second acid reagent 14 for second acidification to prevent the formation of further β-molybdosilicic acid. Fourth is a reduction reagent for reduction of yellow β-molybdosilicic acid to the blue molybdosilicic acid complex. The fully reacted sample leaves the reactor 4 to enter into a secondary debubbler 10, which is located downstream close to the measuring cuvette 1, where the measurement of the absorbance of blue molybdosilicic acid takes place.

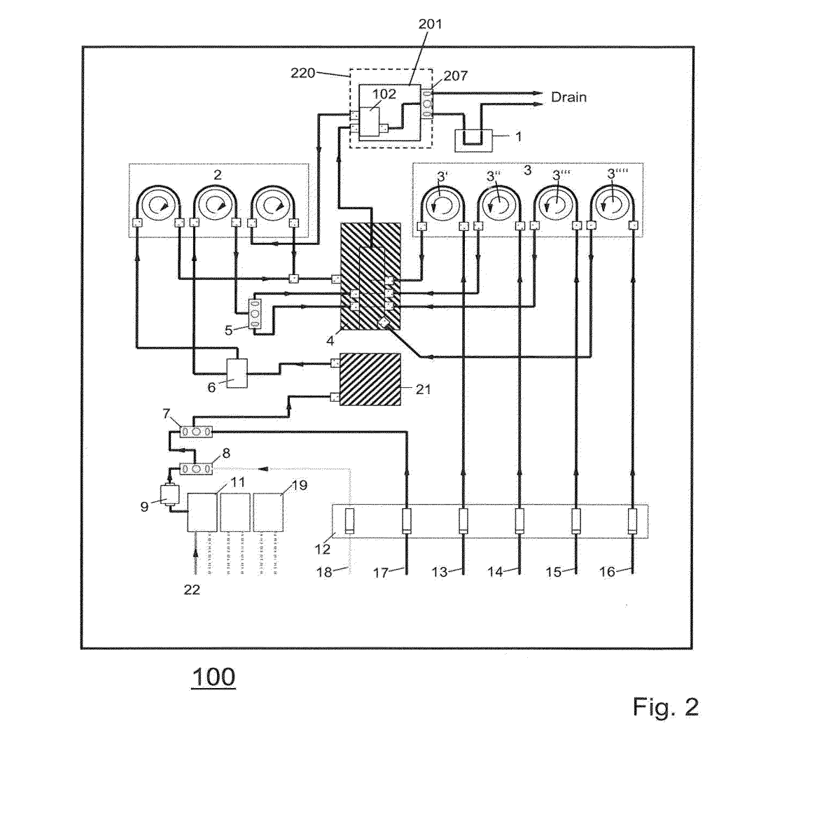

FIG. 2 shows a first embodiment of a chemical analysis apparatus 100 according to the disclosure. It differs from the apparatus shown in FIG. 1 in at least two aspects. Firstly, there is a flow-through pre-heater module 21 arranged downstream the calibration solenoid valve 7 and upstream of the primary debubbler 6, which separate and thermally insulated from the reactor 4. The separate pre-heater module 21 is configured to set the sample temperature independently from the temperature in the reactor, particularly to raise the temperature of the sample stream upstream of the primary debubbler 6 to a higher temperature than the reaction temperature in the reactor 4.

Secondly, at the outlet of the reactor 4 the fully reacted sample stream enters a flow diversion valve assembly 220, which is located upstream of the detection means 1 and downstream of the reactor means 4. The valve assembly 220 is configured to let the fully reacted sample pass through the detection means 1 at a first time interval when the measurement is not being made, and to let the sample flow pass by the detection means 1, leaving the sample inside the detection means 1 in a static state at a second time interval when the measurement is being made.

The flow diversion valve assembly 220 comprises a diverter valve body 207 and a diverter valve manifold module 201, whereby the diverter valve manifold module 201 incorporates a debubbler chamber 102, so that the secondary debubbler is integrally formed as part of the diversion valve assembly.

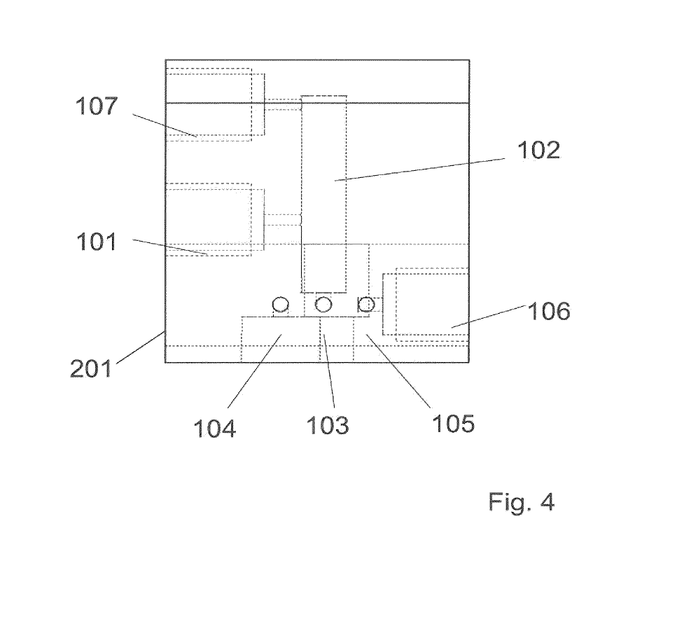

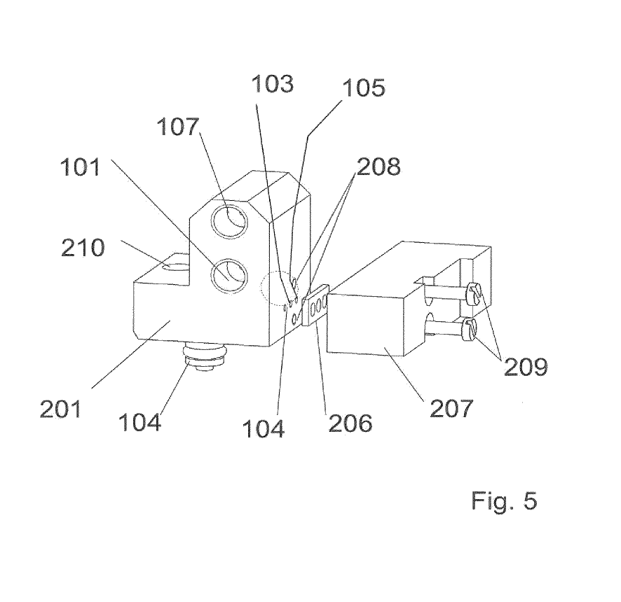

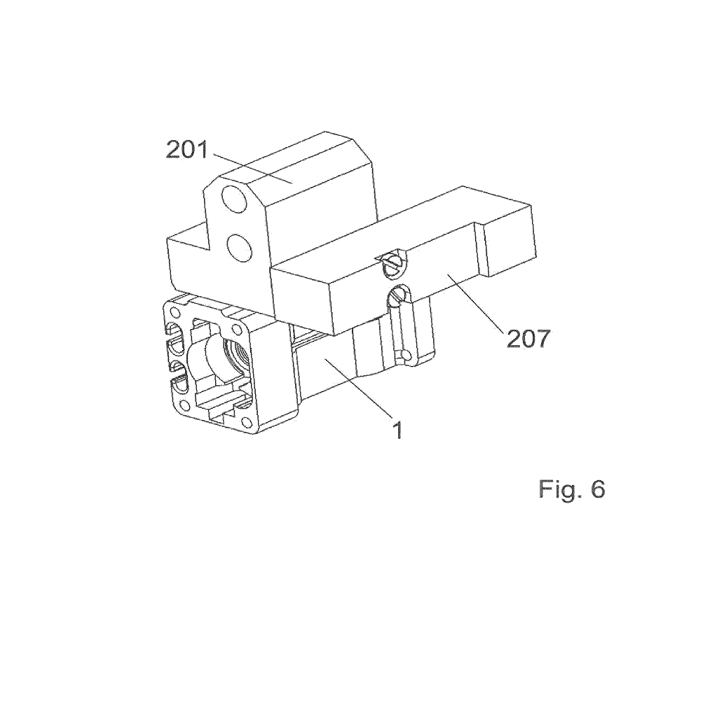

FIG. 4 shows in more detail a schematic view of a diverter valve manifold 201. FIG. 5 shows how the diverter valve manifold 201 is coupled to a diverter valve body 207. FIG. 6 shows the assembled sub-unit comprising the diverter valve manifold 201, the valve body 207 and the measuring cuvette 1. The diverter valve body 207 is fixed to the diverter valve manifold module 201 via two diverter valve mounting screws 209 which are held in diverter valve mounting holes 208 in the diverter valve manifold 201. A diverter valve gasket 206 provides a fluid-tight connection. The measurement cuvette 1 is fixed to the diverter valve manifold 201 via a cuvette mating screw which passes through a recess 210 for module to cuvette mating screw.

The fully reacted, developed sample solution enters the diverter valve manifold 201 at the developed solution inflow port 101 and passes through the integrated debubbler chamber 102. Removed gas bubbles leave through the air outflow port 107. Through a diverter valve inflow port 103 the degassed sample solution enters the valve body 207. In the time when no measurement is made, the sample flow is fed from the valve body 207 to the cuvette 1 through a diverter valve outflow port 104 to the cuvette 1. In the time when the measurement is made, the sample stream is bypassing the measurement cuvette 1 and fed through the diverter valve outflow valve to waste 105 and the waste outflow port 106 to the waste.

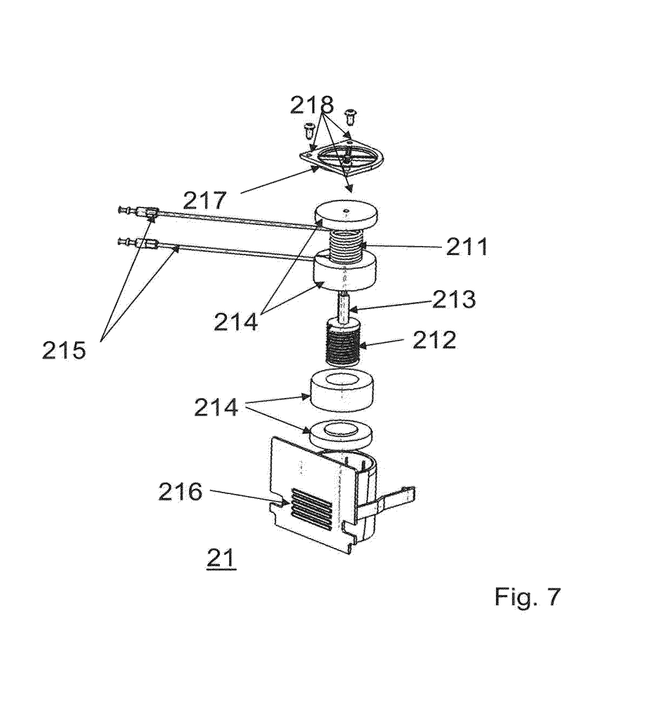

FIG. 7 shows an exploded view of the pre-heater module 21. A pre-heater enclosure 216, covered by a pre-heater enclosure lid 217, fixed with pre-heater enclosure fastening screws 218, contains the pre-heater capillary coil 211 with its tube fittings 215 and which is held between pieces of insulation material 214. The pre-heater capillary coil 211 is wound in the form of a cylindrical coil, inside its core there is positioned a pre-heater bobbin 212 with the heater element 213 with temperature sensor and thermal cut-out.

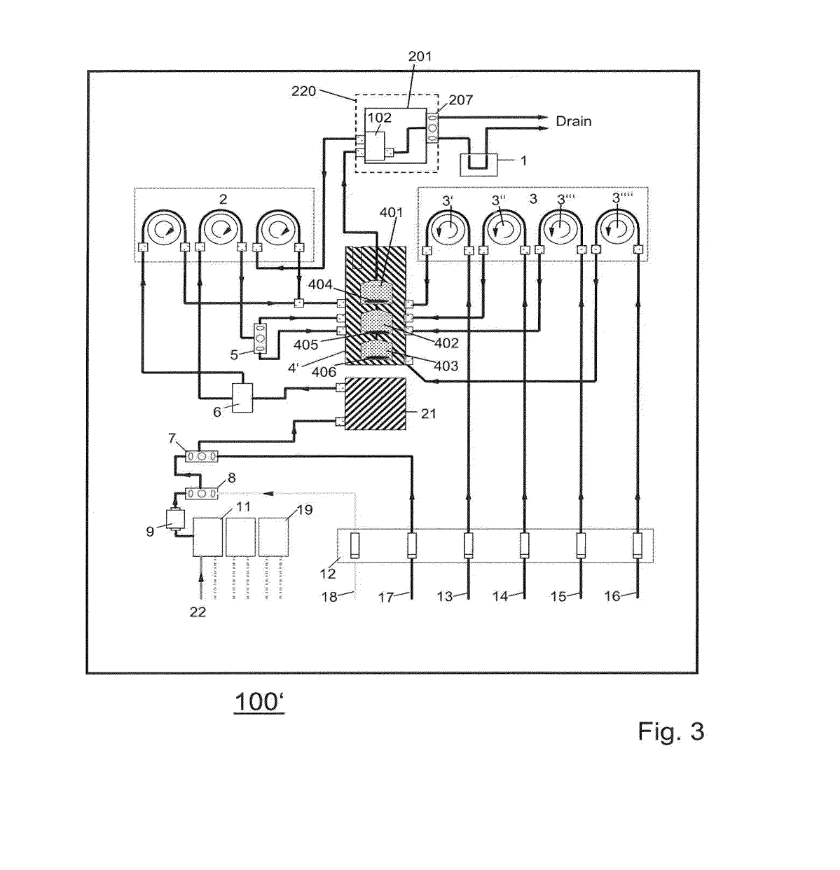

FIG. 3 shows a further embodiment of the disclosure, where the reaction means is realized in the form of a sequential flow-through stirred reactor 4′ comprising a sequential series of reaction chambers 401, 402, 403 for sequentially segmenting the reaction of the reagents with the analyte into a series of partial reactions. Each of the reaction chambers comprises active stirring means or stirrers 404, 405, 406.

The chemical measuring apparatus 100′ shown in FIG. 3 comprises a series of three reaction chambers which are used to segment the reactions required to convert analyte concentration into a measureable color.

Each of the three reactors is stirred mechanically. This can be achieved in a number of ways. One way is to apply a chemically inert magnetic follower within each reaction chamber which is agitated using an induction coil to achieve magnetic coupling.

Alternatively the magnetic drive coupling could be provided by a single rotating spindle with magnetic nodes positioned so as to achieve magnetic coupling for each of the reactor chamber stirrers.

Other means of stirring the contents could be by direct agitation using a paddle, wand, helix or brush. These could be driven directly using a shaft connected to a rotating motor, a reciprocating motor or a motor with an offset weight.

Other means to agitate or stir the reactor contents could be by using Piezo or acoustic devices to induce mechanical movement in the reaction chambers.

Alternatively or in addition to the stirring means or stirrers described above, a further embodiment is to inject air into the reaction chambers. The air pressure and air flow may be chosen such that the air injection by itself will provide sufficient agitation to homogenize the reactants. The air pressure and air flow may also be chosen such that it supports the agitation and homogenization provided by the other stirring means/stirrers described above. The air injection is designed such that the air is passing through the sequential reactors and is removed downstream by the debubbler chamber 102.

Desired characteristics of the reaction chambers according to one embodiment of the disclosure include: they allow the reactants to enter the lower region of the chamber and based on the flow rates, and have a residence time within the chamber such that the desired reaction is substantially completed by the time the contents flow out of the chamber.

The assumption is that each reaction achieves homogeneity within the residence time of the reactor concerned.

The continuous flow of sample and reagents within the segmented reactor design assures that bubbles passing through the system are unable to influence the reactions and hence the extent of color developed. In this way when a bubble finally leaves the reactor system and enters the secondary debubbler in the flow diversion valve assembly 220 before the reaction stream passes through the cuvette, there will be no residual color or refractive index-based perturbation to pass through the cuvette and interrupt the measurement.

This relative immunity to bubbles is achieved because bubbles are unable to disrupt the active mixing process of reagents with sample and because the bubbles themselves pass directly through the reactors and into the secondary debubbler without significant hang-up in the reactor system.

So a system according to the disclosure is less influenced by variations in liquid flow rate and will yield a more stable measurement as a result.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SIGNS

1 Measuring cuvette
2 Peristaltic Pump (Sample)
3, 3′, 3″, 3′″, 3″″ Peristaltic Pump (Reagent)
4 Capillary flow-through reactor
4′ sequential flow-through stirred reactor
5 Zero calibration solenoid valve
6 Primary debubbler
7 Calibration solenoid valve
8 Cleaning solution solenoid valve
9 In-line filter
10 Secondary debubbler
11 Constant-head units
12 Level sensors and filters
13 Reduction reagent
14 Second acid reagent
15 Ammonium molybdate reagent
16 First acid reagent
17 Calibration solution
18 Cleaning solution
19 Constant-head units—additional samples
21 Pre-heater module
22 sample inlet
100, 100′, 100″ chemical analysis apparatus
101 Developed solution inflow port
102 Debubbler chamber
103 Diverter valve inflow port
104 Diverter valve outflow port to cuvette
105 Diverter valve outflow valve to waste
106 Waste outflow port
107 Air outflow port
201 Diverter valve manifold module
206 Diverter valve gasket
207 Diverter valve body
208 Diverter valve mounting holes
209 Diverter valve mounting screws
210 Recess for module to cuvette mating screw
211 Pre-heater capillary coil
212 Pre-heater bobbin
213 Heater element with temperature sensor and thermal cut-out
214 Insulation material
215 Tube fittings
216 Pre-heater enclosure
217 Pre-heater enclosure lid
218 Pre-heater enclosure fastening screw
220 flow diversion valve assembly
401 reaction chamber
402 reaction chamber
403 reaction chamber
404 active stirrer
405 active stirrer
406 active stirrer

What is claimed is:

1. A chemical analysis apparatus, comprising:
a liquid flow train assembly for creating a flowing liquid sample stream guided from a sample inlet through a capillary tubing arrangement at low liquid flow rates, the sample containing an analyte to be measured;
reagents dosing and injection means, located downstream from the sample inlet, for introducing a series of chemical reagents into the sample stream;
reactor means where the reagents are reacting with the analyte for producing a colored chemical indicator in a fully reacted sample; and
detection means for measuring the chemical indicator, said detection means being located downstream of the reactor means and being configured to receive the fully reacted sample with the colored indicator from the reactor means, wherein the flow train assembly is configured to intermittently let the fully reacted sample pass through the detection means at times when a measurement of the indicator is not made, and to bypass the detection means at times when a measurement of the chemical indicator in a sample contained within the detection means is made.

2. The chemical analysis apparatus according to claim 1, comprising:
a flow diversion valve assembly, said valve assembly being located upstream the detection means and downstream the reactor means, said valve assembly being configured to let the fully reacted sample pass through the detection means at a first time interval when the measurement is not being made, and to let the sample flow pass by the detection means, leaving the sample inside the detection means in a static state at a second time interval when the measurement is being made.

3. The chemical analysis apparatus according to claim 2, wherein the flow diversion valve assembly comprises:
a diverter valve body and a diverter valve manifold module, whereby the diverter valve manifold module incorporates a debubbler chamber.

4. The chemical analysis apparatus according to claim 3, wherein the detection means is coupled to the diverter valve manifold module.

5. The chemical analysis apparatus according to claim 1, wherein the flow train assembly comprises:
a flow-through pre-heater module, located upstream of, separate and thermally insulated from the reactor means.

6. The chemical analysis apparatus according to claim 5, wherein the flow train assembly comprises:
a primary debubbling means, located downstream from the pre-heater module and upstream from the reactor means.

7. The chemical analysis apparatus according to claim 5, wherein the pre-heater module is configured to raise temperature of sample stream to a higher temperature than the reaction temperature in the reactor means.

8. The chemical analysis apparatus according to claim 1, wherein the reactor means is a capillary flow-through reactor.

9. The chemical analysis apparatus according to claim 1, wherein the reactor means is a sequential series of reaction chambers for sequentially segmenting the reaction of the reagents with the analyte into a series of partial reactions.

10. The chemical analysis apparatus according to claim 9, wherein each reaction chamber is connected to at least one of the reagents dosing and injection means, for performing at least one of the partial reactions in each reaction chamber.

11. The chemical analysis apparatus according to claim 9, wherein each of the reaction chambers comprises:
active stirring means.

12. The chemical analysis apparatus according to claim 11, wherein the active stirring means are mechanical stirring means for mechanically stirring the sample and reagents or comprise at least a magnetic follower agitated by a magnetic drive coupling device.

13. The chemical analysis apparatus according to claim 9, comprising:
means for injecting air into the reaction chambers to support agitation and homogenization of the reactants.

14. The chemical analysis apparatus according to claim 13, wherein the means for injecting air into the reaction chambers are designed such that air will pass through the sequential reactors for removal downstream by the debubbler chamber.

15. A chemical analysis apparatus comprising:
a sample inlet, and a capillary tubing arrangement, wherein a flowing liquid sample stream containing an analyte to be measured will flow from the inlet, and through the capillary tubing;
reagent dosers and injectors located downstream from the sample inlet, wherein the dosers and injectors are configured and arranged to introduce a series of chemical reagent into the sample stream;
a reactor configured to produce a colored chemical indicator in a fully reacted sample contained therein; and
a detector disposed downstream from the reactor, the detector being configured to receive the fully reacted sample from the reactor, and measure the chemical indicator, wherein the apparatus is configured to intermittently allow the fully reacted sample to pass through the detector when measurement of the chemical indicator is not being made, and to bypass the detector when measurement of the chemical indicator is being made by the detector.

16. The apparatus of claim 15, comprising:
a diverter valve manifold module configured to allow the intermittent flow through, and bypassing of, the detector.

17. The apparatus of claim 16, wherein the diverter manifold module comprises:
a debubbler chamber.

18. The apparatus of claim 15, comprising:
a pre-heater module located upstream from of, separate and thermally insulated from the reactor.

19. The apparatus of claim 18, comprising:
a debubbler located downstream from the pre-heater module and upstream from the reactor.
